(19) United States
(12) Patent Application Publication
(10) Pub. No.: US 2004/0244105 A1
(43) Pub. Date: Dec. 9, 2004

(54) SECURING DEVICE FOR A SHOWER HEAD

(76) Inventor: Chen Tsai, Taichung Hsien (TW)

Correspondence Address: Leong C. Lei, PMB#1008, 1867 Ygnacio Valley Rd., Walnut Creek, CA, 94598-3214, US

(21) Appl. No.: 10/452,509

(22) Filed: Jun. 3, 2003

(51) Int. Cl. A47K 3/00

(52) U.S. Cl. 4/615

(57) ABSTRACT

A securing device for shower head which has a bell-like body mounted with an inlet rod, a spherical rod, a covering cap, filter and water limiting plate characterized in that: a spraying panel is positioned below the interior of the body and has a circular face with a plurality of water outlet holes, the circumferential edge is provided with a plurality of slanting connection plates welded thereto, a scaling pad is mounted at the external of the spraying panel, the support rim is threaded at the center and is connected to a circular body, the bottom end of the inlet rod is externally threaded and is provided with a plurality of inlet holes, the lower section of the inlet rod is externally threaded and is mounted with an O-ring, the inlet rod and the spherical rod, the covering, the water leakage pad, filter and the water limiting plate are mounted and are then the support ring is screwed to the external threads at the lower section of the water inlet rod.

### BACKGROUND OF THE INVENTION

(a) Technical Field of the Invention

The present invention relates to a shower head, and in particular, an improved structure of a securing device for mounting the shower head.

(b) Description of the Prior Art

FIG. 4 is a schematic view showing structure of a conventional shower head. The shower head body 40 is a hood-like shape which is positioned above the top of the user. The top end of the body 40 is provided with an inlet rod 41 which is a hollow tube. The protruded ring at the center of the external rod 41 is a partition for mounting of an upper and bottom external ring. The bottom ring edge of the inlet rod 41 is a bottom end which is a flat surface provided with a water inlet 411. The screw thread on the lower edge ring is mounted with the top end of the body 40. The top end of the inlet rod 41, is a recessed opening formed into a plurality of stepped-like body for the mounting of a water-sealing pad 14. The pad 14 is inserted with a spherical rod 12 and after that a cover 13 is mounted onto the upper end of the rod 12 such that the external of the spherical rod 12 is mounted at the screw threads at the upper end of the inlet rod 41 and the spherical rod 12. The top end of the spherical rod 12 is a recessed opening having an inner edge being threaded for connection with a water pipe after a filter 15 and a water limiting plate 16 are mounted. The opening at the lower section of the body 40 is connected to a spraying panel 42. The method of mounting is by way of connecting the bottom edge of the spraying panel 42 with an extended ring edge and after that, the two elements are welded. However, this conventional method has the following drawbacks

(1) Poor in resisting of pressure, leakage formed easily.

(2) Poor yield in fabrication and the design and quality are affected.

(3) Limit colors in electroplating

(4) Cleaning and maintenance is not easy.

Accordingly, it is an object of the present invention to provide a securing device for a shower head which can mitigate the above drawbacks.

### SUMMARY OF THE INVENTION

An object of the present invention is to provide A securing device for shower head having a bell-like body mounted with an inlet rod, a spherical rod, a covering cap, filter and water limiting plate characterized in that a spraying panel is positioned below the interior of the body and is a circular face with a plurality of water outlet holes, the circumferential edge is provided with a plurality of slanting connection plate welded thereto, a sealing pad is mounted at the external of the spraying panel and the top and bottom end of the connection plate are bent to form a bending face with a specific length and can adhered onto the spraying panel and on the ring face of the support rim for mounting, the support rim is threaded at the center and is connected to a circular body, the bottom end of the inlet rod is externally threaded and is provided with a section of water inlet end, and the ring face of the inlet end is provided with a plurality of inlet holes, and the lower section of the inlet rod is external threaded and is mounted with an O-ring, the inlet rod and the spherical rod, the covering, the water leakage pad, filter and the water limiting plate are mounted and are then the support ring is screwed to the external threads at the lower section of the water inlet rod, whereby the connection plate urges the spraying plate to position the body and the upper end of the body urges the bottom ring face at the middle section of the inlet rod.

Still another object of the present invention is to provide a securing device for a shower head, wherein the connection plate is mounted to the body by means of welding.

Yet another object of the present invention is to provide a securing device for a shower head, wherein the support ring and the inlet rod are mounted by either pivoting or fastening and the connection plate and the spraying panel are mounted to the body.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a securing device for a shower head of the present invention.

FIG. 2 is a perspective exploded view of a securing device for a shower head of the present invention.

FIG. 3 is a sectional view of a securing device for a shower head of the present invention.

FIG. 4 is a sectional view of the conventional shower head.

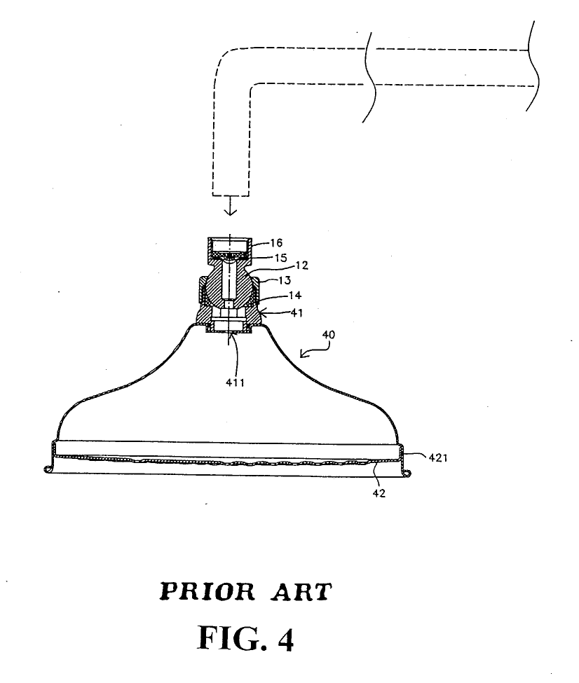

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

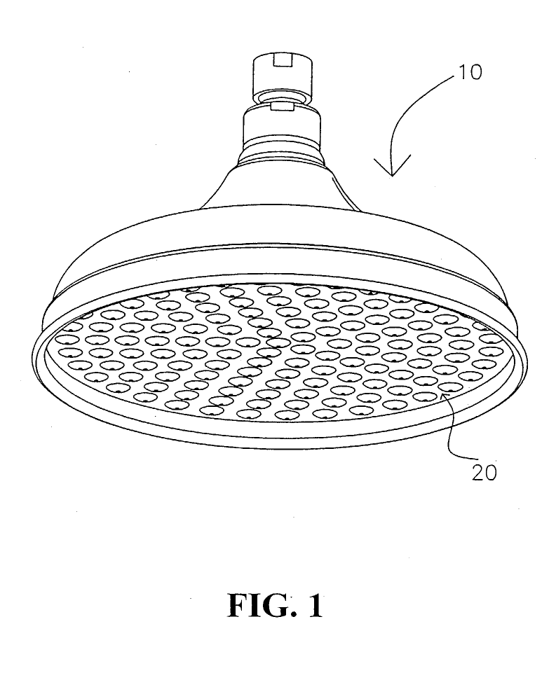

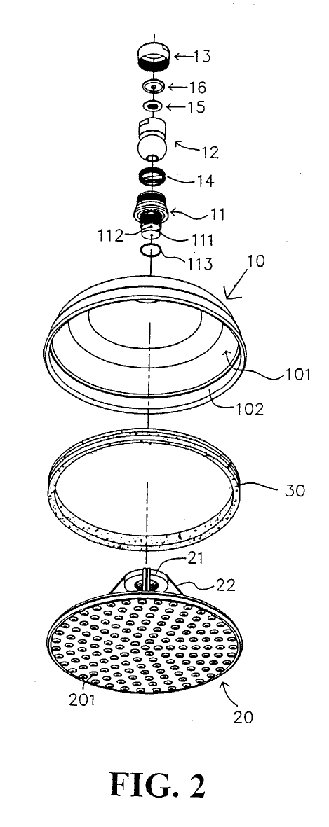

Referring to FIGS. 1 and 2, there is shown a preferred embodiment of a securing device for shower head in accordance with the present invention. In accordance with the present invention, the securing device for shower head has a bell-like body design.

The inner diameter of the bottom of the body 10 of the securing device is extended to form a wide exterior connection ring face 102 for the positioning of the spraying panel 20 after it is inserted thereto. A water inlet cavity 101 is formed between the body and the spraying panel 20.

The spraying panel 20 is positioned below the interior of the body 10 and the panel 20 is a circular face with a plurality of water outlet holes 201. The circumferential edge is provided with a plurality of slanting connection plates 22 welded at the face of the bottom end thereof. A sealing pad 14 is mounted at the external of the spraying panel 20 and the top and bottom end of the connection plate 22 are bent to form a bending face with a specific length and can adhered onto the spraying panel 20 and on the ring face of the support ring 21 for mounting. The support ring 21 is threaded at the center and is connected to a circular body, and the bottom end of the inlet rod 11 is externally threaded and is provided with a section of water inlet end 111, and the ring face of the inlet end 111 is provided with a plurality of inlet holes 112. The lower section of the inlet rod 11 is external threaded and is mounted with an O-ring 113.

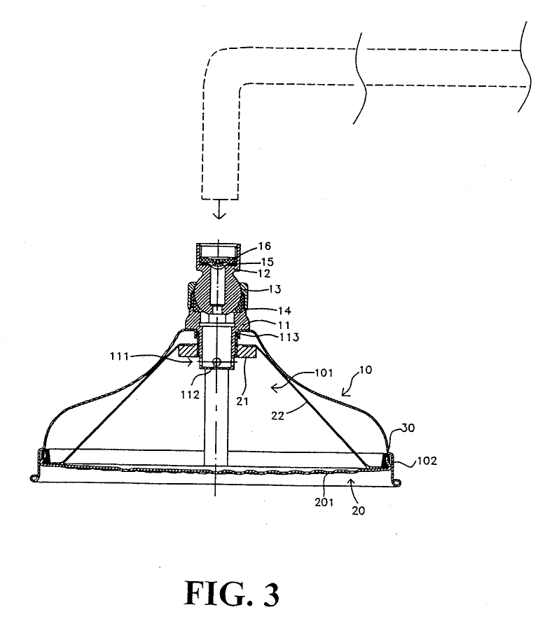

Referring to FIG. 3, the inlet rod 11 and the spherical rod 12, the covering 13, the sealing pad 14, filter 15 and the water limiting plate 16 are mounted. Then, the support ring 21 is screwed to the external threads at the lower section of the water inlet rod 11, whereby the connection plate 22 urges the spraying plate 20 to position the body 10 and the upper end of the body 10 urges the bottom ring face at the middle section of the inlet rod 11.

In accordance with the present invention, the advantages of the present invention are provided with the following advantages:

(1) Rapid in installation, strong in structure, and high safety features. The structure of the securing device has a greater strength as compared to the conventional welding type of shower head. The structure of the present invention allows rapid installation.

(2) Compact and easy maintenance. There is no welding process used in the securing device. Instead a sealing pad is used and therefore maintenance work becomes simple.

(3) Aesthetic Design. There is no welding in the course of combination and therefore the appearance of the shower head provides an aesthetic design.

(4) Different types of color electroplating and different colors combinations. The spraying panel and the body can be mounted together with screws and therefore various types of color electroplating can be applied individually and thereof the combination thereof varies according to personal taste.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1-3. (canceled)

4. A securing device for a shower head having a body mounted with an inlet rod, a rod, a covering cap, a filter and a water limiting plate, wherein a spraying panel is positioned below an interior of the body and has a circular face with a plurality of water outlet holes, a circumferential edge is provided with a plurality of slanting connection plates welded thereto, a sealing pad is mounted at the exterior of the spraying panel and top and bottom ends of the connection plates are bent to form a bending face with a specific length and can adhere onto the spraying panel and on a surface of a support ring for mounting, the support ring is threaded at a center which is engaged with the inlet rod, a bottom end of the inlet rod is externally threaded and is provided with a water inlet end, a surface of the inlet end is provided with a plurality of inlet holes, a lower section of the inlet rod is externally threaded and has an O-ring, and the support ring and the inlet rod are mounted by either pivoting or fastening and the connection plates and the spraying panel are mounted to the body.
